(19) United States
(12) Patent Application Publication
(10) Pub. No.: US 2003/0097316 A1
(43) Pub. Date: May 22, 2003

(54) Method and system of managing procurement processes by manipulating line items

(75) Inventors: Glen B. Dunbar III, Fairfax, VA (US); Ted D. Smith, Fredericksburg, VA (US)

Correspondence Address: STAAS & HALSEY LLP, 700 11TH STREET, NW, SUITE 500, WASHINGTON, DC, 20001, US

(73) Assignee: American Management Systems, Fairfax, VA

(21) Appl. No.: 10/298,005

(22) Filed: Nov. 18, 2002

Related U.S. Application Data
(60) Provisional application No. 60/331,527, filed on Nov. 19, 2001.

(51) Int. Cl. G06F 17/60

(52) U.S. Cl. 705/28

(57) ABSTRACT

A procurement system includes a procurement unit and an item allocator. The procurement system is coupled to access units which allow users to manage a procurement process by manipulating line items on one or more source documents as they are transferred to one or more target documents. The user is provided with the capability of combining or splitting items from one or more source documents as they are transferred from the target document. The system is capable of maintaining a tracking history for each of the items as it is edited.

### CROSS-REFERENCE TO RELATED APPLICATION

This application is related to and claims priority to U.S. provisional application serial No. 60/331,527, by Dunbar et al., filed Nov. 19, 2001, entitled Line Item Allocator, the content of which is hereby incorporated by reference.

### BACKGROUND OF THE INVENTION

1. Field of the Invention

The present invention is directed to a method and system of managing a procurement process and particularly to a system and method which manages line items on procurement documents.

2. Description of the Related Art

Governments and corporations have developed various sets of procedures for procuring goods and services. The basic process for procuring such goods and services begins with the generation of a requirement, purchase request or procurement request (PR). As an example, Edward Jones, a Requirements Analyst in a Department of Defense Program Office, has been requested to acquire aerial refueling systems (ARS) for aircraft supported by his office. To fulfill the requirement, Edward prepares a procurement request (PR) which includes a number of line items and a government estimate for the cost of the ARS. The line item information includes a description of work, the available funds, the delivery location, quantities and other details of the project. Once the PR is completed (i.e., approved), Mr. Jones forwards the PR to a contracting office where the refueling systems will be procured via a solicitation.

The next step in the process is to prepare a solicitation. For example, Judy Adams, a Contract Specialist in the Contracting Office, receives the PR from Edward Jones, completes the necessary pre-solicitation steps and prepares an appropriate solicitation. The content of this solicitation includes the PR line item information as well as other appropriate contract clauses and terms. Once this solicitation is complete (i.e., approved), Judy makes the solicitation (also referred to as Request for Proposal (RFP) or Request for Quote (RFQ)) available to the public (e.g., vendors). The government cost estimate for the ARS does not appear on the solicitation.

The next step in the procurement process is the receipt of offers. As an example, the Acme Company and five other vendors submit offers in response to the solicitation. Judy Adams receives the offers and documents that they were received within the time frame specified in the solicitation. Next the evaluation of offers and the selection of a vendor occurs. Judy Adams evaluates the received offers based on the criteria in the solicitation. She then prepares the necessary evaluation documentation (i.e., business clearance/memorandum and any supporting pre-award documentation) which recommends a vendor/offer for award. Judy submits the evaluation documentation to management for approval.

Once the evaluation documentation has been approved, a contract is prepared based on the solicitation and offer information. Judy creates the appropriate award document based on the solicitation and offer information, and the necessary accompanying documentation. The line items for the ARS are updated to reflect the agreed upon costs. Judy forwards all of the information to the appropriate approval authority. Once the award document is completed (i.e., approved and signed) it is ready for contract administration.

In the contract administration process, changes to the contract may be made by way of contract modifications. This activity continues until the contract is closed out (i.e., all deliveries and payments are made). Once all deliveries and payments have been made and all associated documentation is complete, the contract is then closed out. The contract is retained by the government for the time specified in the close out documentation.

Examples of available procurement systems for handling the basic procurement process include the Standard Procurement System (SPS) developed by American Management Systems, Inc. (AMS) and CACI, which includes the Procurement Desktop System (models PD-1 and PD 2) manufactured and sold by AMS. A description of a procurement management system developed by the assignee of the subject application is described in co-pending application Ser. No. 09/220,380 filed Dec. 24, 1998, the contents of which is hereby incorporated by reference, and in co-pending application Ser. No. 09/556,966 filed Apr. 24, 2000, the contents of which is hereby incorporated by reference.

### SUMMARY OF THE INVENTION

It is an aspect of the present invention to provide a procurement method and system having flexibility to manipulate the line items in one procurement document in order to transfer the line items to another procurement document in a way which is more flexible and useful for business.

It is another aspect, of the present invention to provide a procurement method and system which includes the capability of combining one or more items on one or more documents to form a single item on the same or another procurement document.

In another aspect, the present invention provides a procurement method and system in which an item on a procurement document may be split into two or more items on the same or another procurement document.

In another aspect, the present invention provides a procurement method and system which include the capability of providing a tracking history for items as they are edited and moved between documents.

The above aspects can be attained by a system that includes a procurement unit and an item allocator. The item allocator manipulates at least one item on at least one source document as the at least one item is transferred to at least one target document.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of an embodiment of a procurement system in accordance with the present invention.

FIG. 2 is a diagram illustrating the operation of the item allocator 34 in FIG. 1 in accordance with the present invention.

FIG. 3 is a diagram illustrating one aspect of the operation of the procurement system in accordance with the present invention for a scenario involving the basic allocation of items from a source document to a target document.

FIGS. 4A, 4B, 4C, and 4D are screen shots illustrating the user interface which is provided in connection with the operation of the scenario of FIG. 3.

FIG. 5 is a diagram illustrating one aspect of the operation of the procurement system of the present invention for a scenario involving the allocation of items to a delivery order.

FIGS. 6A, 6B, 6C and 6D are screen shots illustrating the user interface which is provided in connection with the operation of the scenario illustrated in FIG. 5.

FIG. 7 is a diagram illustrating one aspect of the operation of the procurement system in accordance with the present invention for a scenario in which an allocation of items is made to an amendment or modification which is related to an existing target document.

FIGS. 8A, 8B, 8C and 8D are screen shots illustrating the user interface which is provided in connection with the operation of the scenario illustrated in FIG. 7.

FIG. 9 is a diagram illustrating one aspect of the operation of the procurement system in accordance with the present invention for a scenario in which items are allocated to a modification of a delivery order.

FIGS. 10A, 10B, 10C and 10D are screen shots illustrating the user interface which is provided in connection with the operation of the scenario illustrated in FIG. 9.

### DETAILED DESCRIPTION OF THE PREFERRED EMBODIMENTS

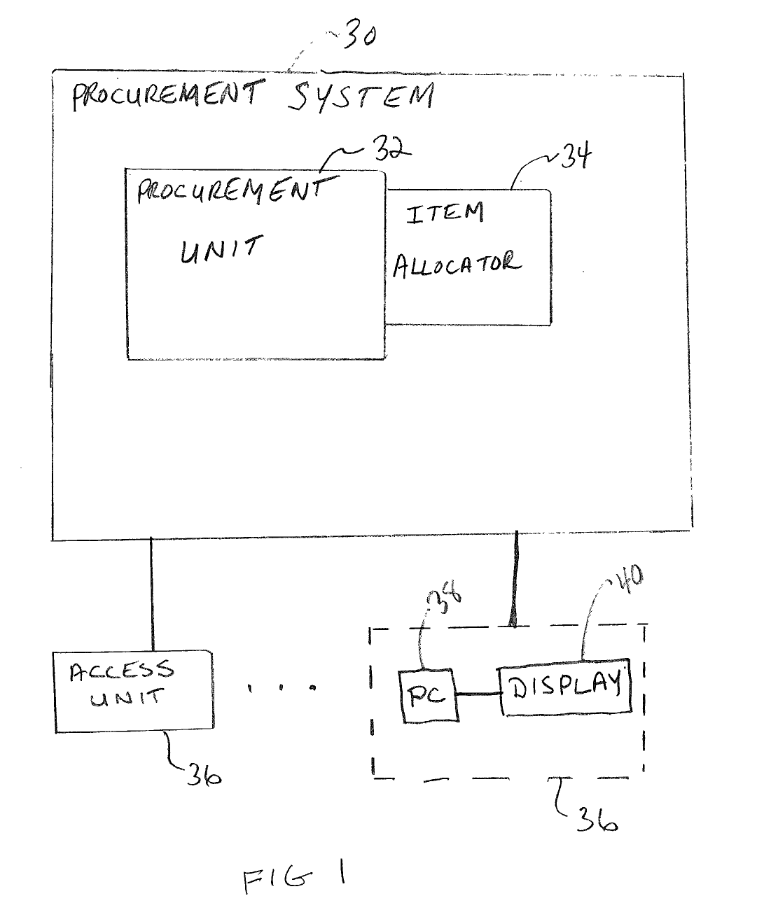

Referring to FIG. 1, the procurement system 30 in accordance with the present invention includes a procurement unit 32 and an item allocator 34. The procurement unit 32 and the item allocator 34 are coupled to a plurality of access units or user stations 36 to allow users to access the procurement system 30. The procurement system 30 includes permanent or removable storage such as magnetic and optical disks, RAM, ROM, etc. on which the process and data structures of the present invention can be stored and distributed. The processes can also be distributed via, for example, downloading over a network such as the Internet. The access units 36 may include a computer 38, such as a PC, and a display 40. The users at the access units 36 are coupled to the procurement system 30 by any one of a number of different types of connections including, for example, via the Internet through a web browser, or over a local area network (LAN).

The procurement unit 32 may be of the type identified in the above-identified application Ser. No. 09/220,380 filed Dec. 24, 1998, the above-identified application Ser. No. 09/556,966 filed Apr. 24, 2000, or any other available type of procurement system. Procurement system 30 in accordance with the present invention may be deployed as a web-based scalable, modular and open procurement system which works within an integrated acquisition environment. It is capable of operating on a variety of hardware platforms and of supporting heavy transaction volumes. The procurement system 30 in accordance with the present invention is capable of supporting database independence through Java 2 Enterprise Edition (J2EE) and Java Database Connectivity (JDBC) standards. If the access units 36 are operated as a browser-based user interface then the hardware and software requirements for a system owner are reduced, and sharing of information among geographically diverse business functions is available. Further, in the case of a browser-based implementation, the browser provides the client-side user interface using a standard web browser such as MS Internet Explorer or Netscape Navigator. Further, the user interface is standards-based, using HTTP, HTML and Dynamic HTML (Document Object Model and Events) and Java Script.

The procurement unit 32 handles the basic processing of the documents involved in the procurement process. The types of documents involved in the procurement process can be categorized as source documents and target documents. Both the source documents and the target documents include a number of items which are sometimes referred to as line items. Such items include standard contract clauses, delivery instructions and attachments, as well as specific information identifying quantities, types and funds for both products and services. In the subject application the terms item and line item are used interchangeably.

A source document is a document from which one or more items are drawn to be transferred to another document which is referred to as a target document. Typical source documents include:

a procurement request or purchase request (PR)

a PR amendment

a solicitation, also referred to as a request for proposal (RFP), a request for quote (RFQ), and an invitation for bid

a solicitation amendment or an offer evaluation, also referred to as a bid, a proposal or a quote

a modification or amendment

an award/agreement (also referred to as a contract)

an IDC (Indefinite Delivery Contract) Order, Agreement Order, ordering instrument, delivery order or delivery order modification

Except for the PR, which tends only to be referred to as a source document, all of the other documents identified above may be considered a source document in one situation, and the same document may serve as a target document during another point in the procurement process. It is also noted that in certain circumstances, ordering documents are considered a separate category of documents from source documents and target documents. However, in the context of the subject application, such ordering documents are considered to correspond to source documents and target documents. Further, the above is not an exhaustive list of the types of documents involved in the procurement process. Therefore, the terms source and target documents as used herein, are meant to refer to any procurement document having items therein which are capable of being managed during a procurement process.

The features of the present invention can be used to split and combine items, both at the item level and at the document level. In the case of splitting an item at the item level, one item on a source document is split into two items on a target document. Similarly, combining items on the item level involves combining two items on a source document into a single item on a target document. Document level splitting involves splitting a single item on a source document into two items which are distributed to target documents. Similarly, combining at the document level involves combining two items from separate source documents into a single item in a target document.

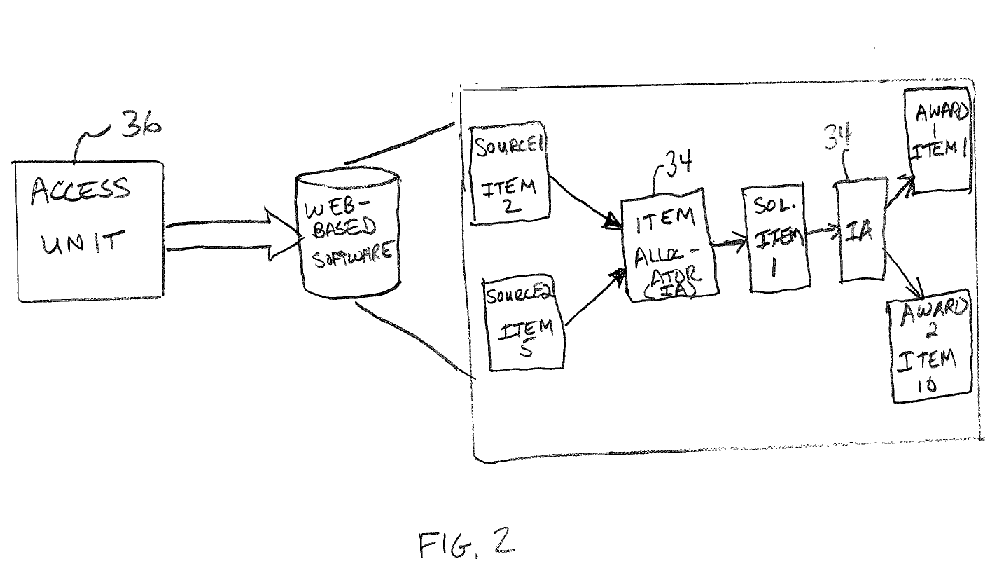

The item allocator 34 provides the advantageous features of the present invention by manipulating one or more items on one or more of the source documents, as the one or more items are transferred to one or more target documents. Such manipulation can be in the form of editing an item on a source document before it is transferred to a target document, and this editing can be performed either automatically or based on input from the user at a user station 36. As described above, both document level combining and splitting and item level combining and splitting may be performed. FIG. 2 is a diagram illustrating an example of the operation of the item allocator 34 in conjunction with input from a user at access unit 36 via a web browser. As illustrated therein, the user at access unit 36 is working with first and second source documents which are identified as SOURCE 1 and SOURCE 2. Based on user input to the item allocator 34, or based on automatic allocation, item 2 of the first source document and item 5 of the second source document are combined by item allocator 34 to form item 1 in a solicitation document which acts as a target document. Then, item allocator 34 manipulates item 1 of the solicitation document (which now is a source document) so as to split this item into two items on two target documents which are referred to as AWARD 1 and AWARD 2. For example, a portion of item 1 from the solicitation document is inserted on item 1 of AWARD 1 and another portion of item 1 of the solicitation document is inserted on item 10 of AWARD 2. The item allocator 34 is also capable of tracking the allocation history of an item and of producing any desired report showing such tracking history.

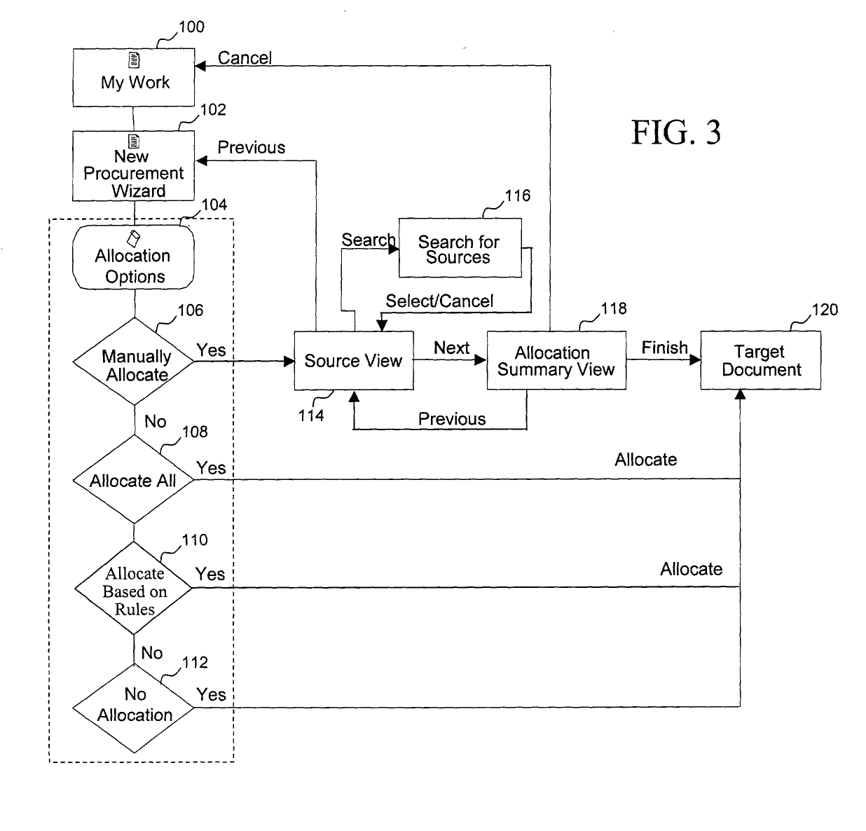

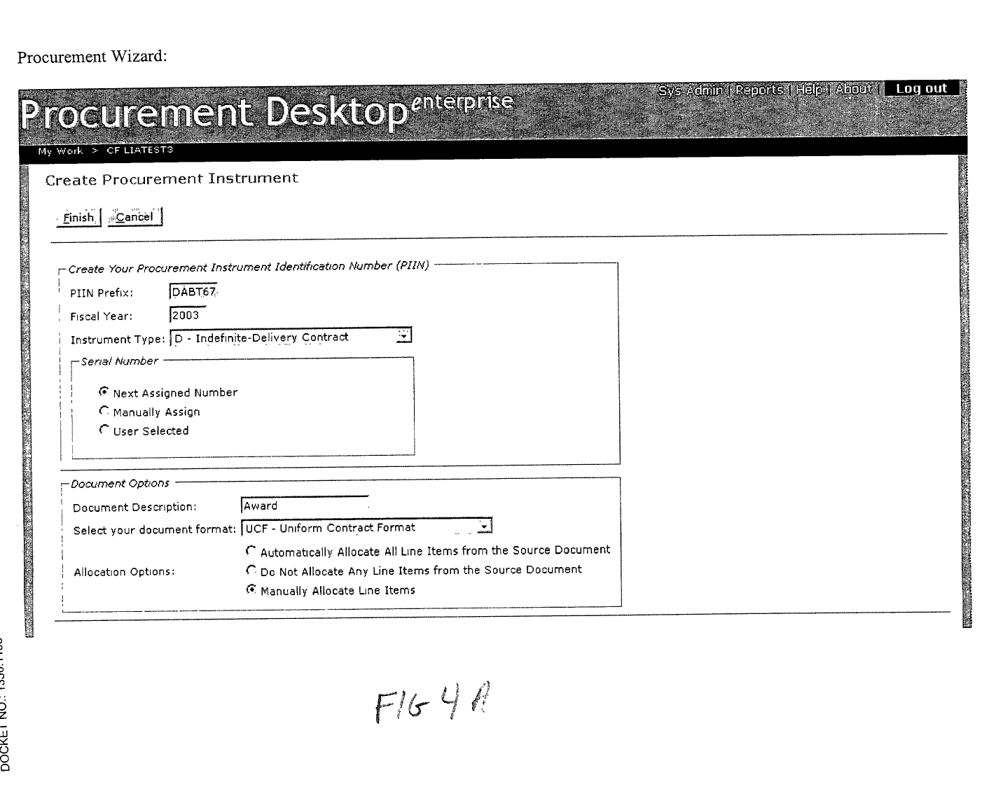

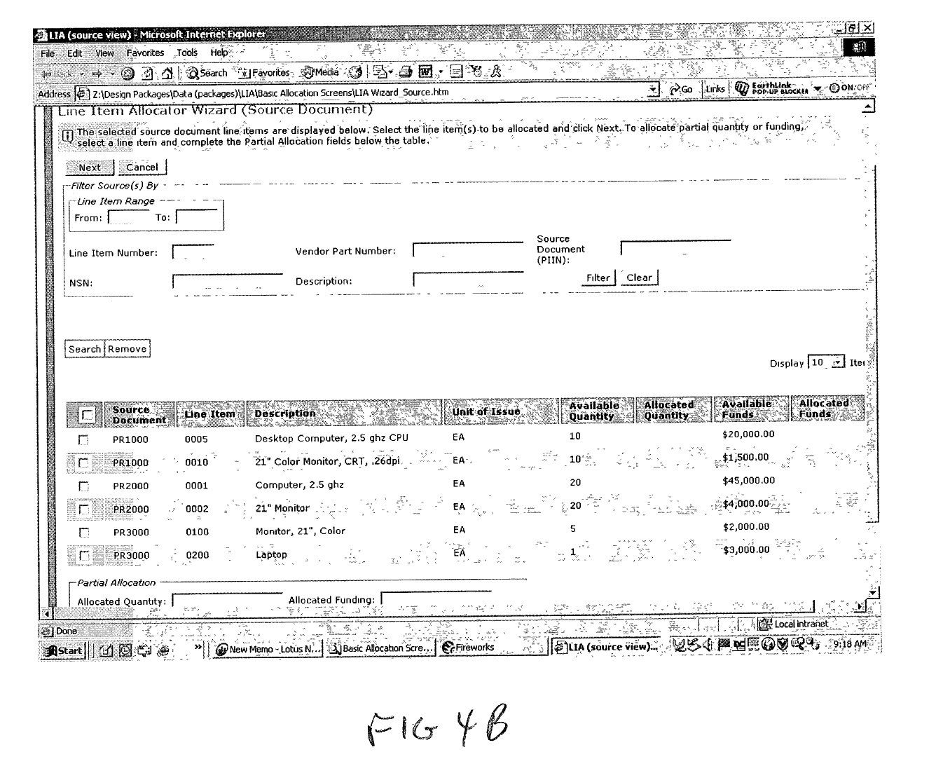

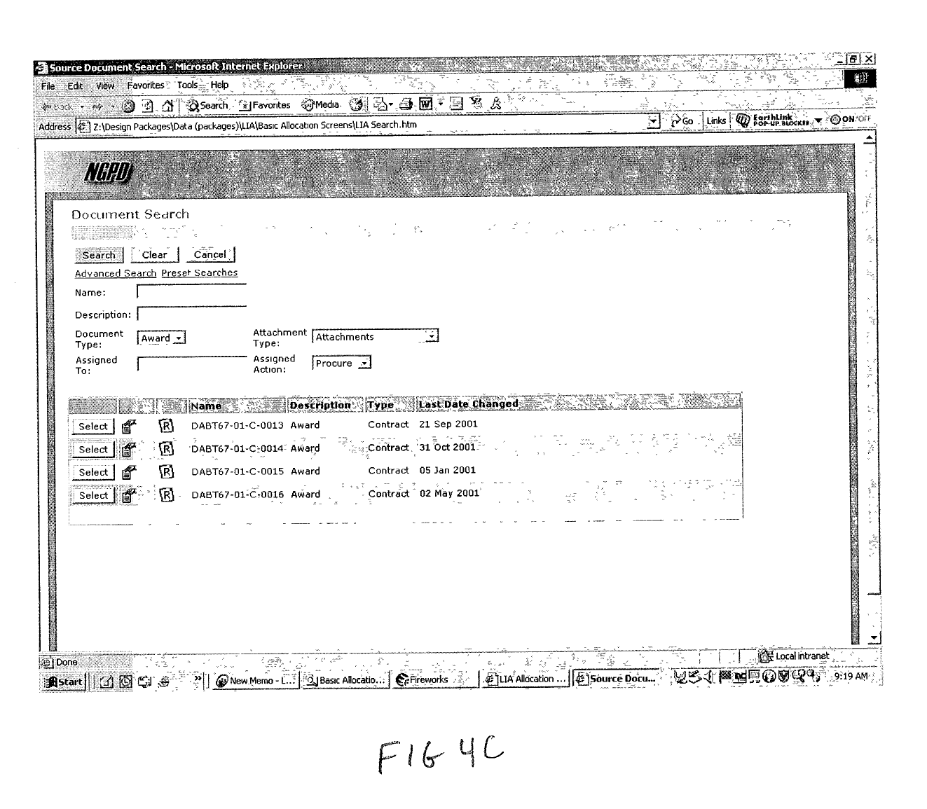

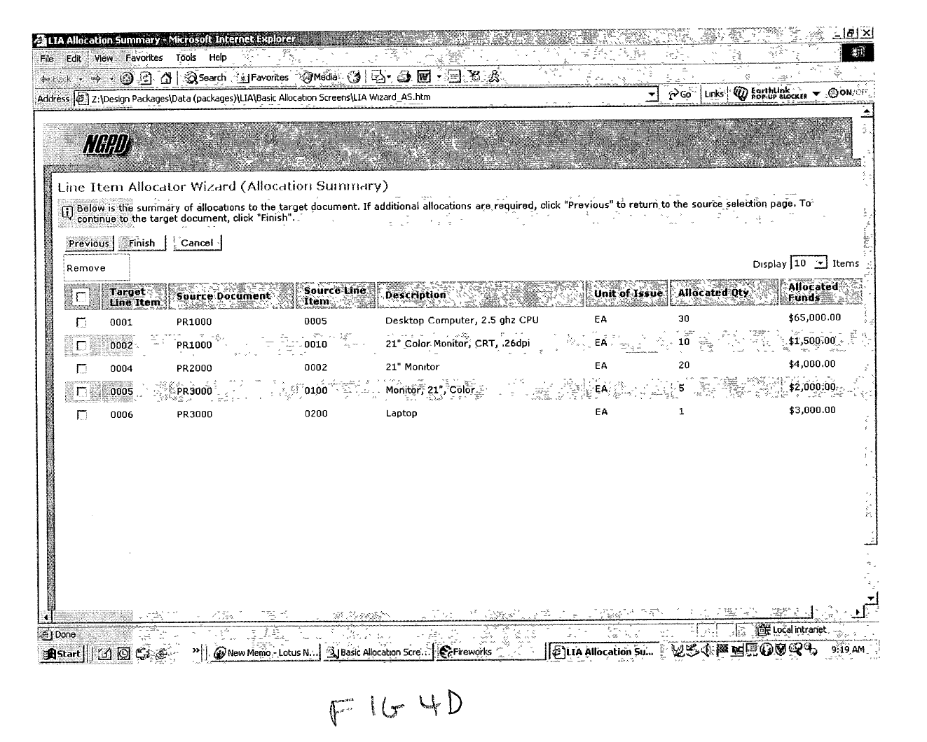

FIG. 3 is a diagram illustrating the operation of the item allocator 34 in cooperation with the procurement unit 32 and the access units 36 for a scenario involving the basic allocation of items or line items from one or more source documents to one or more target documents. The user at access unit 36 is able to display and select from multiple source documents which constitute the user's work at 100. Typical available source documents might include a plurality of purchase requests (PRs), or PR amendments requesting creation of a new procurement document. The user sets up a new procurement wizard to develop a target document at 102. The new procurement wizard allows the user to determine a number of features of a target document. For example, the user is able to select a number of standard items for inclusion in the target document. Such standard items might include standard terms and conditions, as well as standard attachments which need to be attached to the target document. The screen shot of FIG. 4A provides an example of a user interface which is provided by the new procurement wizard in order to allow creation of a procurement document. As a part of this operation the user is also provided with a set of allocation options at 104. The allocation options allow the user to determine whether to manually allocate at 106, to allocate all items at 108, to allocate automatically based on rules at 110, or to perform no allocation at 112. If allocate all is selected at 108, then all items in the current source document are allocated to the target document. A no allocation selection at 112 essentially means that no line items are pulled forward to the target document. This is typically done when the user does not wish to make an allocation at that time.

If allocate based on rules is selected at 110 then an automatic allocation of selected line items in the source document(s) is made to select and edit items for the target document based on predetermined rules. Such rules could determine that allocation should be made for quantities or dollar funding above or below certain levels. For example, an automatic allocation rule could state that if quantities of a specific product on separate items are below an identified minimum, these separate quantities are automatically combined into a single item on a target document (e.g., an RFP). For example, if a first PR (source document 1) has an item which includes one box of pencils and a different PR (source document 2) also includes an item identifying one box of pencils, these two items may be combined automatically based on a rule, into a single item identifying two boxes of pencils. Alternatively, quantities which are above a predetermined amount could be automatically split. For example, if a single PR had an item including a large quantify of a product, this item could be automatically split into separate items on two target documents, (e.g., two RFPs). Therefore, the use of automatic allocation based on predetermined rules can be very useful in streamlining the procurement process and in reducing the number of procurement documents which are prepared.

If manually allocate is selected at 106 then the user is provided with a view of items from one or more source document(s). Specifically, as illustrated in the screen shot attached as FIG. 4B, selected source document line items are displayed for the user from one or more source documents, and the user is allowed to select items to be allocated to the target document.

The user is provided with the capability of allocating partial quantities or partial funding (i.e., dollars) by selecting an item and then completing one of the partial allocation fields at the bottom of the screen of FIG. 4B to select a partial quantity or partial funding. This is an illustration of splitting at the item level. In an alternate embodiment, the user may allocate partial quantities or partial funds on the same line as the item. By using the partial allocation features of the present invention, a user is able to manually allocate items or portions of items to various specialists, for example, vendors who have a particular field of specialty. In addition, the partial allocation of funding feature used in accordance with the present invention allows a checkbook approach or incremental funding approach, to the allocation of particular funds. That is, the available funds may be decremented as partial allocations occur for a particular line item.

As illustrated in the upper portion of the screen shot of FIG. 4B, the present invention includes a filter feature by which certain items may be filtered out if the user does not wish to work with those items during a current session. Such filtering may occur based on vendor part number, source document number, National Stock Number (NSN) or any other feature for which filtering is desired.

While the user is viewing the selected source document line items in the screen shot of FIG. 4B, the user is able to conduct a search of sources at 116 ((FIG. 3), wherein the user is provided with a display corresponding to the screen shot of FIG. 4C. For example, as illustrated in FIG. 4C, the user may be looking for a statement of work or other standard clauses which are found in a set of attachments to other documents such as awards which have already been prepared. The user is provided with the results of the search which include a display of a set of documents which may be selected. The user is allowed to select certain attachments or clauses from the documents developed in the search. This allows selected clauses, attachments, etc. to be moved forward into the target document. Once the search is completed, the user then returns to the source view at 114.

After the user has clicked on “Next” in the source view of FIG. 4B, the user is provided with the screen shot of FIG. 4D which presents the user with a summary of allocations which have been made to the target document. In this case, the user has combined line item 5 of source document PR 1000 with line item 1 of source document PR 2000 (see FIG. 4B) to form a single target line item 0001 for thirty (30) desk top computers (see FIG. 4D). The user is allowed to make additional allocations by clicking on the “Previous” button to return to the source view. If the user desires to proceed to the target document the user clicks “Finish”.

When the user clicks on “Finish” in the screen shot of FIG. 4D, the target document is prepared at 120 (FIG. 3). The target document will include all of the line items allocated as indicated in FIG. 4D plus any other basic terms, clauses, etc. which have previously been/allocated to the target document.

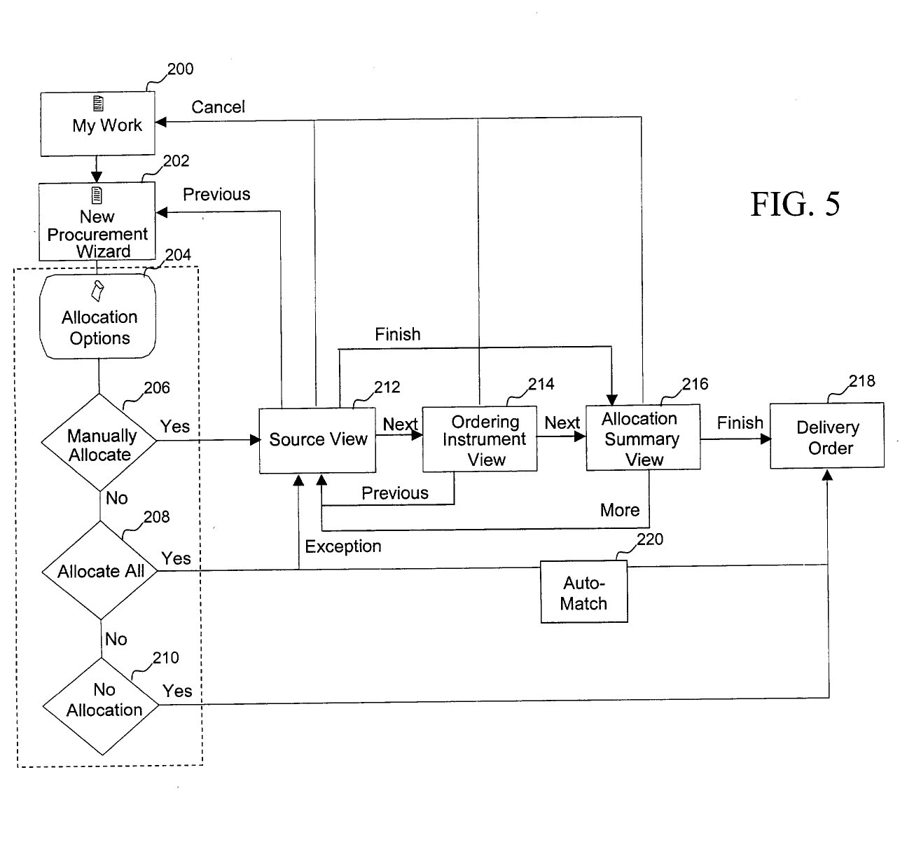

Another feature of the present invention relates to the allocation of items to a target document which is a delivery order. For example, a user receives a released purchase request (PR) containing a line item for 100 pairs of pants and 20 silk ties. The user knows that there is an existing indefinite delivery contract (IDC) (also known as an ordering instrument or long term contract) for clothing. The system creates a delivery order item by automatically matching an item from the PR with the corresponding item for pants on the ordering instrument (OI). The user then matches the item for silk ties to an order instrument. This operation of the procurement system of the present invention for allocation of a delivery order is described in detail below with reference to FIG. 5. As illustrated therein, the user at access unit 36 views a number of source documents that make up the user's work at 200 and uses the procurement wizard at 202 to select various options for preparing a delivery order. The procurement wizard acts a contract vehicle for creating a delivery order. The user interface is illustrated in FIG. 4A.

As described above, the user may use the wizard to select a number of standard terms and conditions and attachments to be placed into the delivery order. If no allocation is selected, this essentially means that the user does not wish to allocate line item information to the delivery order at this time. One of the options provided by the procurement wizard relates to allocation options as indicated at 204. The allocation options provided include manual allocation at 206, allocation of all items at 208 and no allocation at 210.

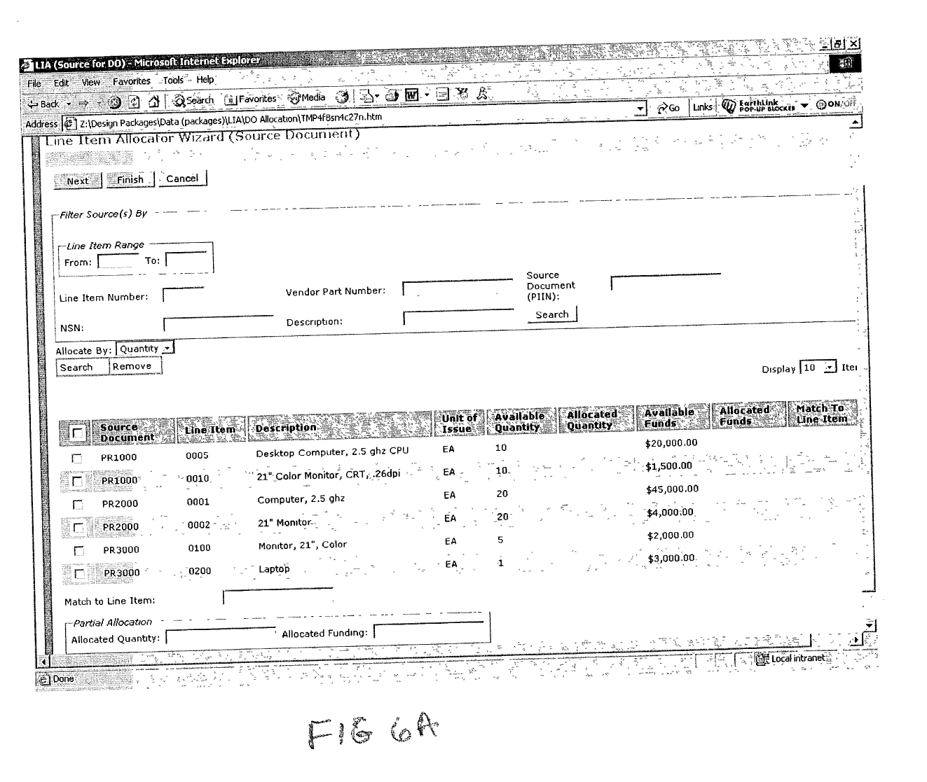

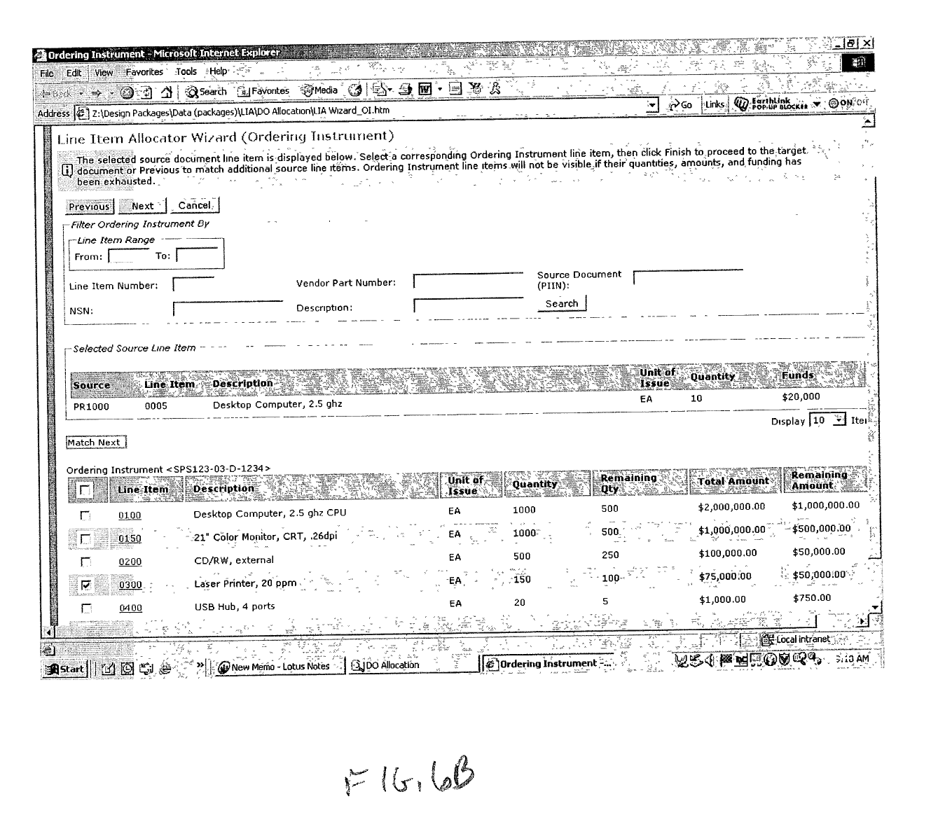

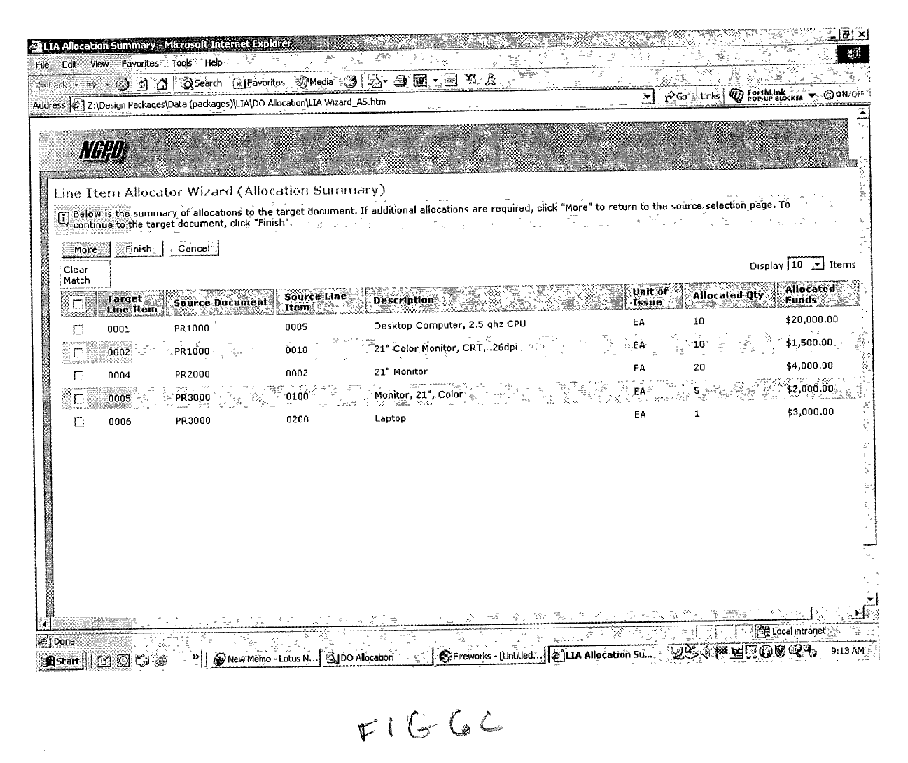

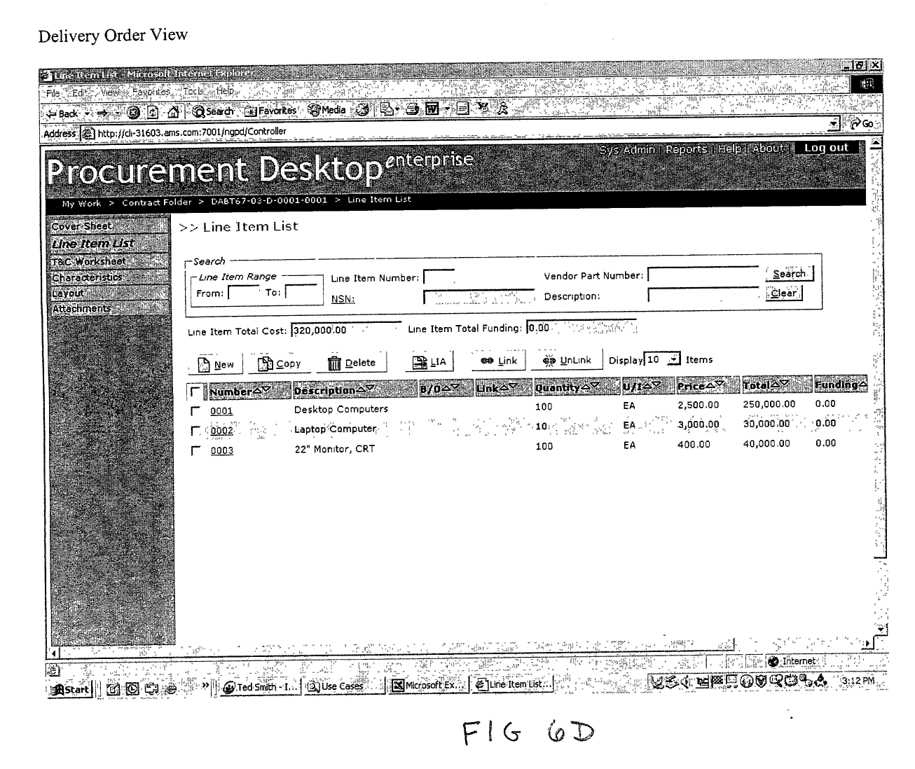

If no allocation is selected at 210, this generally means that the user has decided not to work on the specified items at this time. If the user selects manual allocation at 206 then the user is provided with a source view at 212. This is illustrated by the screenshot of FIG. 6A which is a view having a number of source line items. It is to be noted that this screen shot is very similar to the source view of FIG. 4B and includes similar features with respect to filtering and partial allocations. However, in this circumstance, the item allocator is being used to prepare a delivery order. As illustrated by the screen shot of FIG. 6A the user is provided with the option of allocating by either quantity or by amount. Allocation by amount is particularly useful for services. For example, if the user is seeking the delivery of janitorial services but does not wish to allocate the entirety of the available amount, a partial allocation may be made. Such a partial allocation could not be made for this type of service if allocation was only available by quantity. In addition, near the bottom of the screen shot there is a field provided for “match to line item”. By using this field, the user can type in a line item of an ordering instrument so as to match a particular item from the source view with a known ordering instrument. In general, the user is provided with the opportunity to select one, or a portion of one, of the items to match with an ordering instrument. When the user selects an item and clicks on “Next” then an ordering instrument view is provided to the user at 214.

An exemplary screen shot of an ordering instrument view is provided in FIG. 6B which shows a selected source line item and instructs the user to select a corresponding ordering instrument line item. The ordering instrument line items reflect available quantities of different products and services which are available under an existing contract. The user is instructed to select a corresponding ordering instrument line item and click “Previous” to match additional source line items. The ordering instrument line items are not visible if the quantities, amounts or funding have been exhausted. Note that the ordering instrument view of FIG. 6B includes remaining quantity and remaining amount fields. The features of the present invention allow for providing business rules or restrictions which limit the amounts of the remaining quantities or the remaining funds which may be used up by a particular match. For example, it could be required that the matching of selected products be defined such that a match must be for more than 10 and less than 100 units.

After the user has matched one or more line items from the source document to the ordering instrument and has clicked “Finish” to proceed to the target document, then the user is provided with an allocation summary view at 216. The allocation summary view which is illustrated at FIG. 6C, provides the user with a summary of allocations to the target document. The user may click on “More” to return to the source selection view of FIG. 6A or may click “Finish” to proceed with creation of the delivery order at 218. The delivery order includes overlaid clauses, terms, attachments and line items to make a complete contract with the vendor.

The creation of a delivery order using the automatch operation 220 is implemented if the user selects the allocate all option at 208. In the automatch operation, the system attempts to match the source items which have already been designated by the user with selected ordering instrument items (which can be considered to be additional source or reference items) based on any or all of a number of criteria including National Stock Number (NSN), manufacturing part number, vendor part number, North American Industry Classification System (NAICS), Federal Supply Classification (FSC), Standard Industrial Classification (SIC), Weapon System Code (WSC), program, suggested contract line number, description, or extended description. If more than one ordering instrument item meets the above criteria or if only part of the description is matched, then an exception occurs and the user is provided with the source view at 212 and proceeds through the above-described operation of manual matching. If matching of all line items occurs then a full automatch takes place at 220 and a delivery order is created at 218 based on the matching. FIG. 6D is a screen shot of a list of line items that have been developed for a delivery order. As indicated in the screen shot, these quantities can then be adjusted prior to the finalization of the deliver order.

The scenario of FIG. 5 can also include features which constrain the creation of the delivery order. For example, business rules can be set in place to specify maximum and minimum quantities for delivery orders. For example, if an ordering instrument specifies a specific number of computers, it could be that the business would not want the entirety of the quantity specified in the ordering instrument to be used up by a single department requesting a delivery. If the constraints in the system are violated, then the user will be provided with a warning screen advising them of this fact.

The present invention is also capable of providing for a situation wherein existing contracts or other documents can be amended or modified. In this case, the source document may be, for example, a purchase request, but the target document is not a new document but is instead a modification to an existing contract. It is noted that changes to an existing contract are generally referred to as modifications, while changes to documents other than contracts, (for example, purchase requests, RFPs., etc) are generally referred to as amendments. However, the terms modification and amendment are used interchangeably herein.

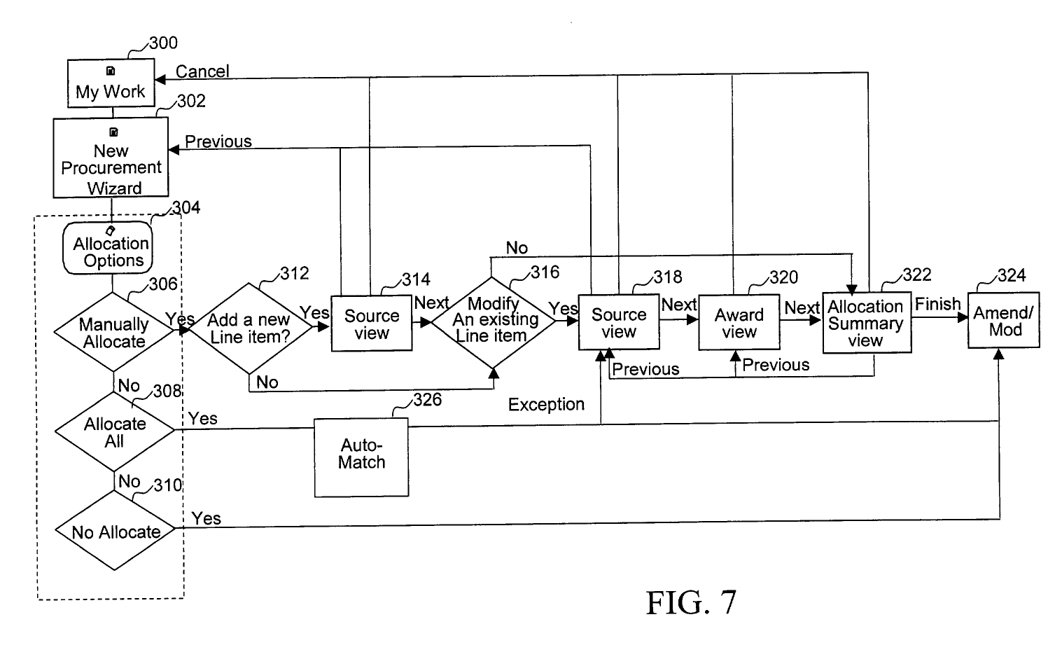

The amendment/modification feature of the present invention is described below with reference to FIG. 7. The user receives within his or her work a request specifying a change in an existing target document at 300. The procurement wizard requests information from the user such as the identification of the target document to be modified and also provides the usual array of options to the user including allocation options at 304. The user interface is similar to the one illustrated in FIG. 4A. The allocation options under this scenario include manual allocation at 306, allocate all at 308, and no allocation at 310. The selection of no allocation at 310 generally indicates that the user does not wish to allocate the information on this request at the current time.

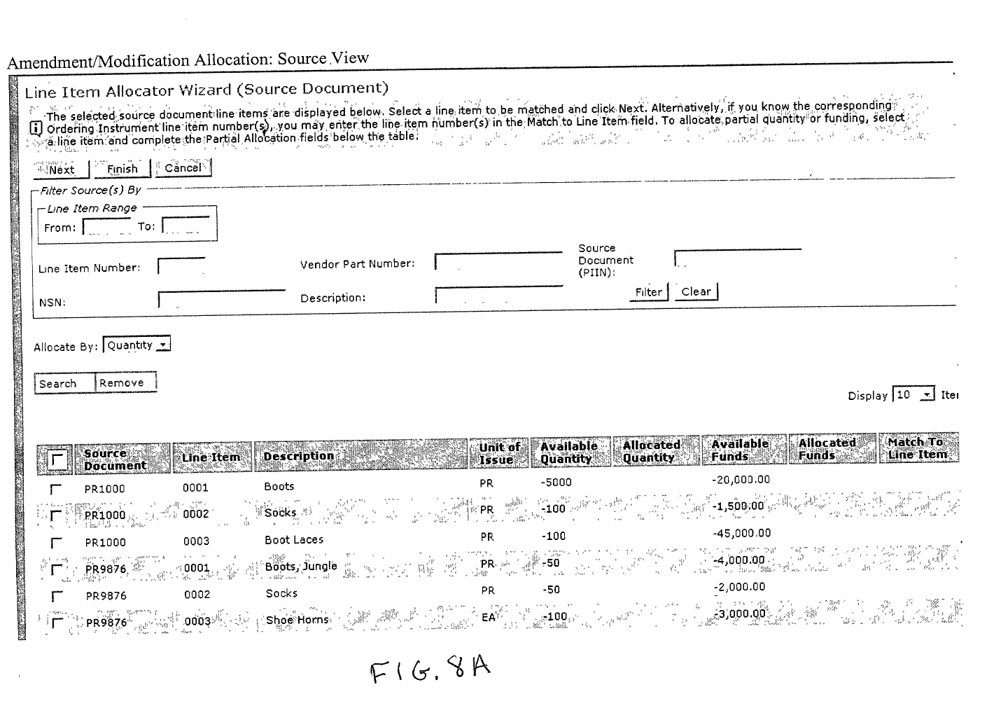

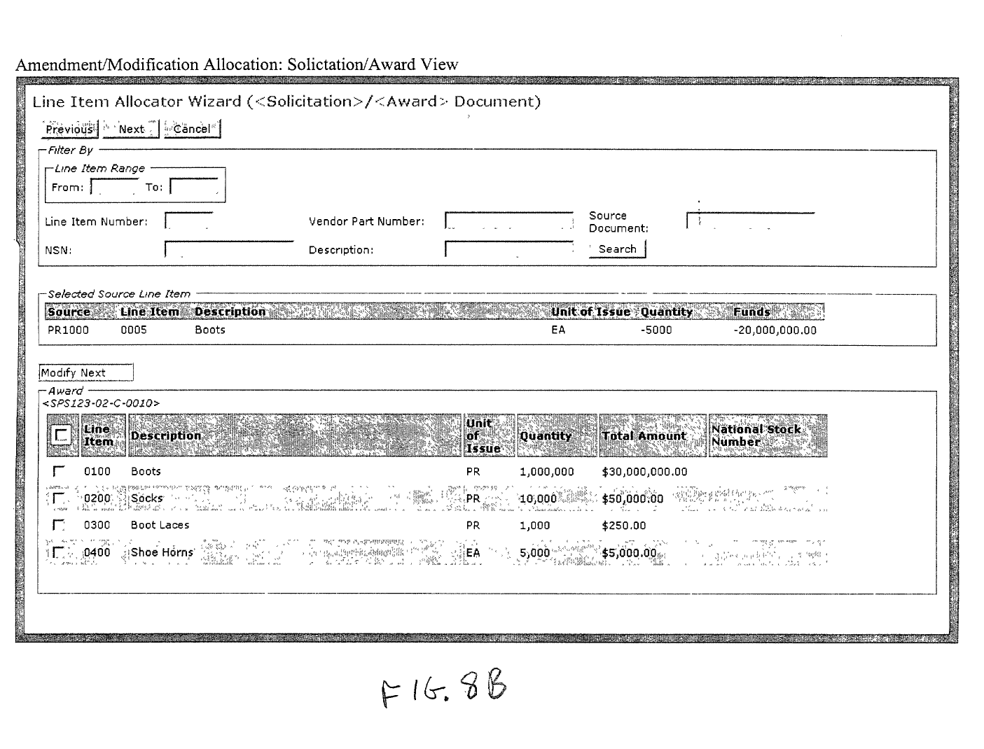

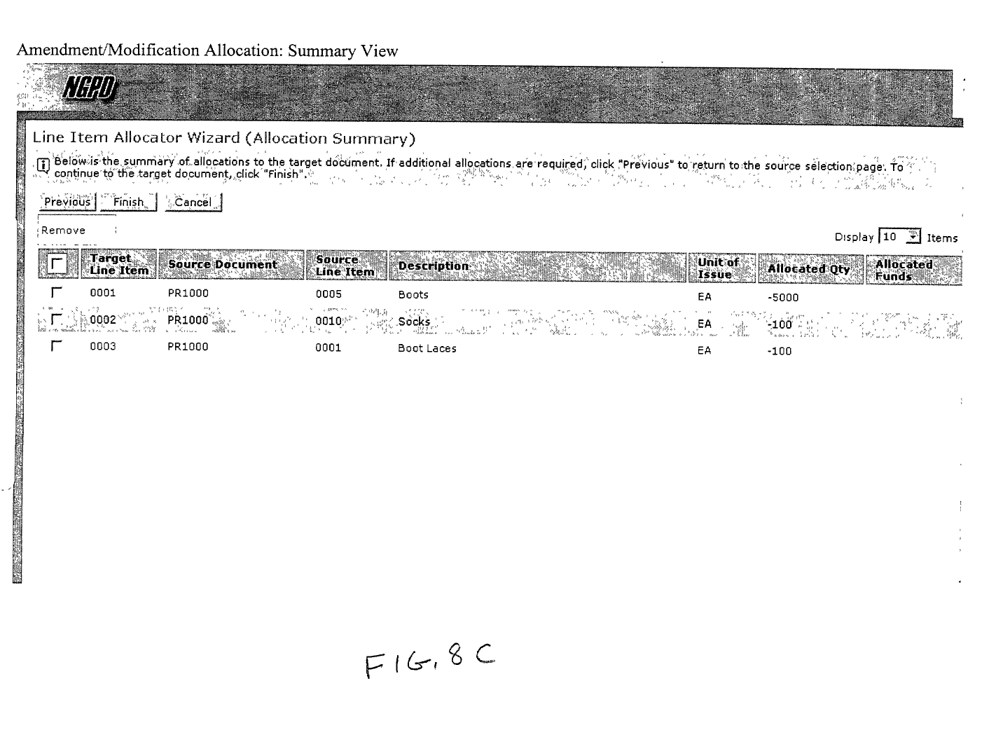

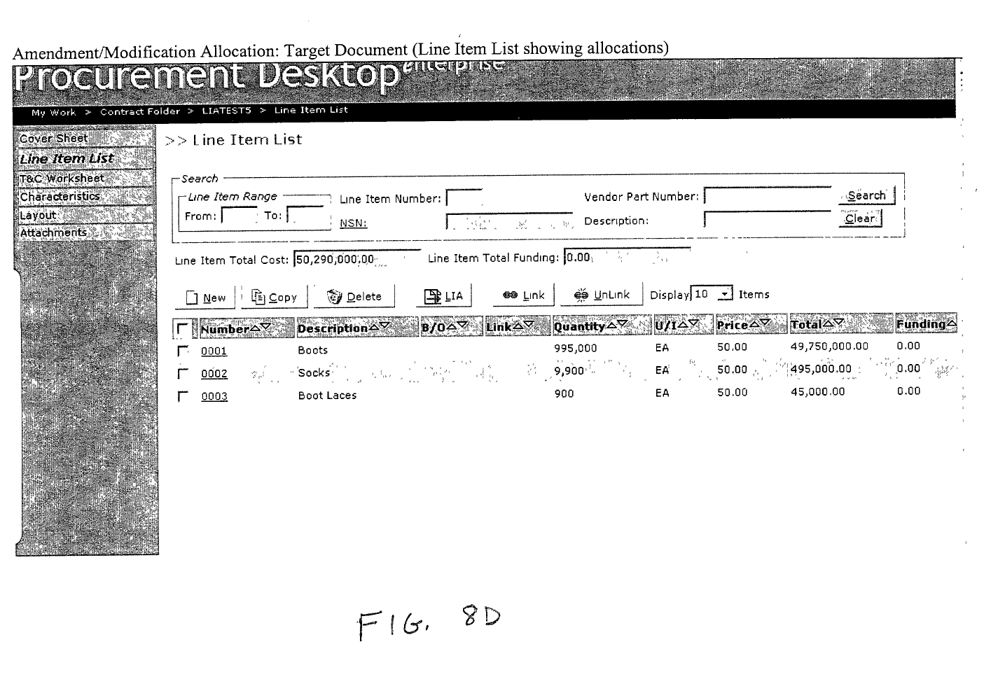

If the user selects manual allocation at 306, then the user is asked whether a new item is being added at 312. If a new item is being added, the user is provided with a source view at 314. This source view is illustrated, for example, by the screen shot of FIG. 8A which includes a listing of source line items which can be added as a modification or an amendment. After the user selects of one or more items from the view of FIG. 8A or if the user has indicated that a new line item will not be added at 312, then the system asks the user whether an existing line item is to be modified at 316. If an existing line item is to be modified, then a source view is to be provided to the user at 318 and the user is allowed to select one or more items for modification. This source view is illustrated, for example, in FIG. 8A.

After the user has selected a line item for amendment or modification and clicks on “Next”, then the user is provided with a view illustrating the target document. Such a view is illustrated by the screen shot, for example of FIG. 8B. In this view the user is allowed to increment or decrement the quantities or funds for one or more of the identified items. In this regard, the system is capable of employing a “delta-centric” approach in which the change in the desired quantities or funding is indicated, as opposed to restating the total desired quantity or funding. After modification is made to one item, the user may click on the “Modify Next” button and proceed to modify additional items until finished. After all modifications are completed, the user clicks on the “Next” button, and the user is provided with an allocation summary view at 332 to show the user the amendments or modifications which have been selected. An example of such a modification allocation summary view is illustrated in FIG. 8C. The allocation summary view provided at 322 is also provided if it is determined that an existing line item is not to be amended at 316.

Once the user is provided with the allocation summary view and determines that these allocations are accurate, then the user clicks on “Finish” and the amendment or modification is prepared at 324. FIG. 8D is an illustration of a screen shot provided to the user to show a listing of items which are being modified or changed. In addition to providing an amendment or modification which reflects only the changes to the line items, the system is also capable of preparing a conformed copy of the procurement document so that the current state of the document is always available.

If at 308 the user requests allocation of all of the source line items prepared for the modification, then the system performs an automatch operation at 326 in which it attempts to match the source items to the items in the target document and to create modifications based on this matching procedure. If a match cannot be determined between the target document and a particular source item then an exception is generated and the user is provided with the source view at 318 to allow the user to manually match the identified line item to the appropriate item in the target document. The accuracy of the automatch operation 326 can be enhanced if the user enters the appropriate target document item number or numbers for the items to be modified.

Note that in the automatch operation 326, the existence of an exception sends the flow to the source view at 318 which relates to modification of an existing line item. This is because if a new item is added, it is automatically entered into the operation or modification and there is no need to match it up with an existing item. If the automatch operation cannot locate a corresponding item in the target document, it will attempt to key on other available information such as vendor part number, NSN, etc.

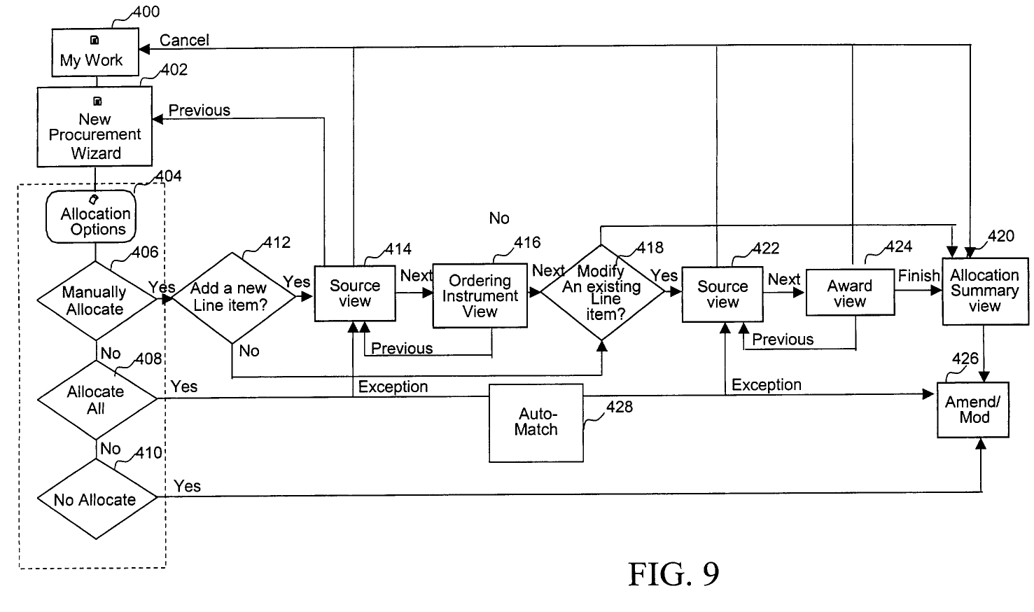

The scenario of allocating a modification to a delivery order in accordance with the present invention is illustrated by the diagram of FIG. 9. In this scenario, the user receives a document such as a request for a charge which is displayed on the user's work list at 400. The user then initiates the creation of a modification by using the procurement wizard at 402. As in the other scenarios, the procurement wizard provides the user with a series of options for preparing the modification including the allocation options at 404 (see user interface of FIG. 4A). As described above, the allocation options allow the user to manually allocate the modifications at 406 to allocate all modifications at 408 or to make no allocation at 410. As in the other scenarios, if no allocation option is selected at 410 the process terminates. This is typically done when the user does not wish to allocate the item information to the modification at the current time.

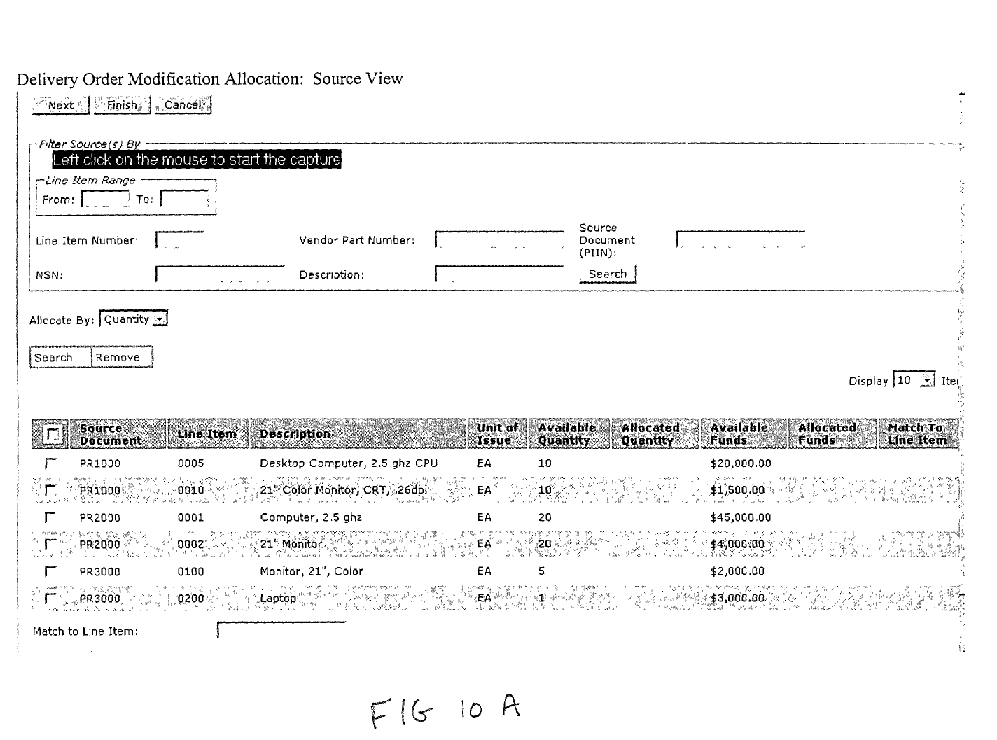

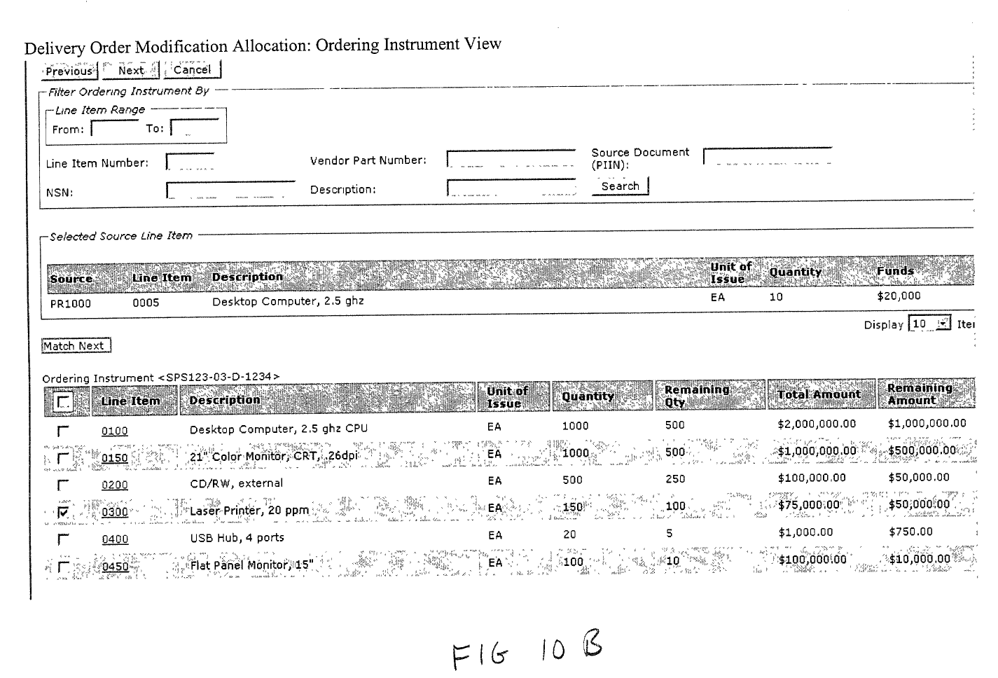

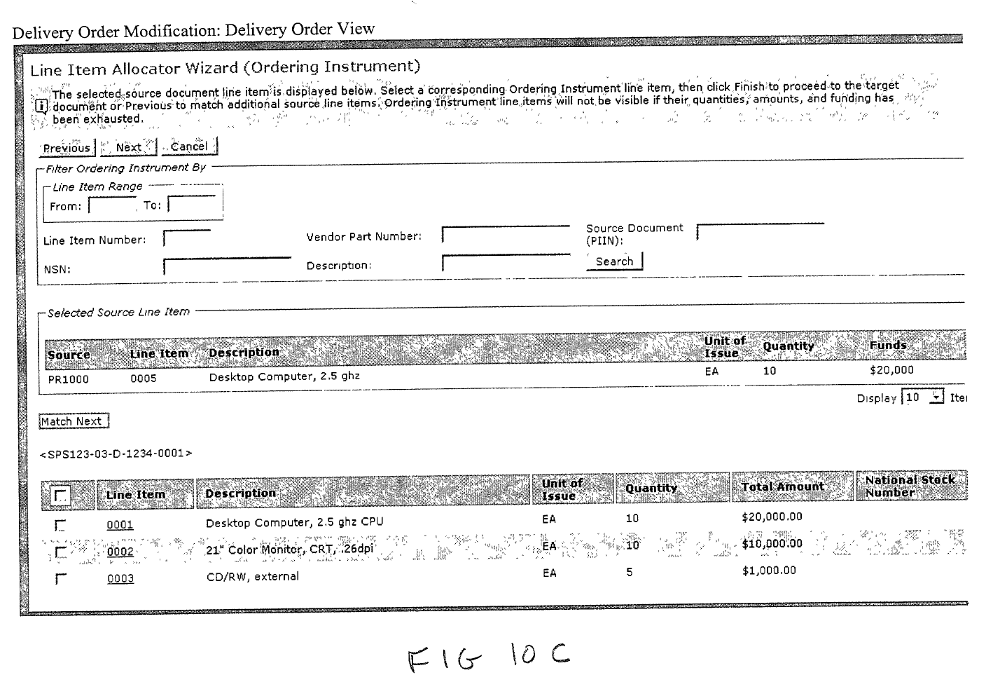

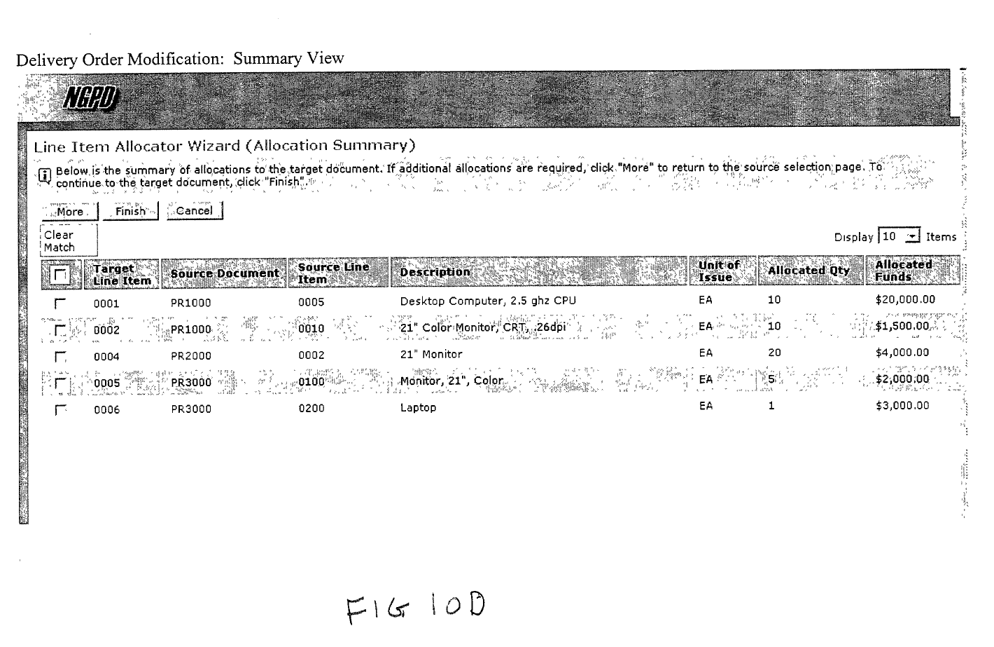

If the user elects to manually allocate, then at 412 it is determined whether a new item is being added. If a new line item is to be added, then the operations for making this modification are similar to the allocation to a delivery order illustrated in FIG. 5. That is, the user is provided with a source view at 414 which is illustrated by the screen shot of FIG. 10A. The user is then able to select a new item and match it with an ordering instrument based on the ordering instrument view at 416. Exemplary screen shots of an ordering instrument view are provided in FIGS. 10B and 10C which show a selected source line item (i.e., 10 desktop computers) and instruct the user to select a corresponding ordering instrument line item. If additional items are to be added, then the user clicks on “Previous” to return to the source view of FIG. 10A. Once new items and the correct ordering instrument have been matched at 416, the user will click on “Next”. The user is then asked whether they would like to modify an existing line item at 418, and if not, the user is provided with an allocation summary view at 420. FIG. 10D is a screen shot of a summary view of a delivery order modification which is produced for the user at 420. This screen shot provides the user with a summary of allocations which have been made to the delivery order modification. Note that if the user indicated that a new line item was not to be added at 412, the flow also proceeds to ask the user whether the user wishes to modify an existing line item at 418.

If the user wishes to modify an existing line item at 418 then the user is provided with a source view at 422 which allows the user to select which items are to be modified. This source view is illustrated by the screen shot of FIG. 10A. The user then allocates selected modifications based on a view of the target document such as the solicitation or award at 424. This view is similar to the screen shot of FIG. 8B described above. After the modifications have been allocated to the appropriate line items of the target document, the user clicks on “Finish” and the allocation summary view of FIG. 10D is provided at 420 as described above. Then the amendment or modification is created at 426 in a manner similar to that described above with respect to the amendment/modification 324 in FIG. 7.

If the user does not decide to manually allocate at 406 but instead decides to allocate all at 408, then an automatch operation occurs at 408. In this process the system attempts to match the modifications identified by the user to an existing ordering instrument and a target document such as a solicitation or an award. If all modifications can be matched then an amendment or modification is created at 426. As described above with respect to FIG. 7, the amendment or modification identifies only the changes to the basic document. In addition, a conformed copy of the document which includes all changes can be created. If the modifications cannot be fully matched, then an exception occurs and the system forwards the process into the flow of the manual allocation process in a manner similar to that described above with respect to FIG. 7.

As described above, the method and system of the present invention have a number of features which enhance the procurement process. These features include an auto allocation feature, an allocation tracking feature, a manual allocation feature, a conflict detector and other allocation features.

The auto allocation feature provides for automatic manipulation of items as they are allocated from the source document to a target document based on a set of customized business rules. For example, items may be allocated from one or more PRs to one or more solicitations based on a set of business rules. Further, such automatic allocation can be based on rules specifying the combining and splitting of various line items. In addition, such auto allocation features can be achieved with respect to a plurality of different kinds of source documents and a plurality of different kinds of target documents. That is, the above described solicitation can become a source document which is then used to automatically allocate items to an award. The relationship of the auto allocation feature to delivery orders includes features of automatic sourcing to locate an ordering instrument and an automatch feature which is performed based on NSN part number or description. Auto allocation can also occur with respect to the above-described modification scenario. For example, auto allocation can occur from a source document such as a PR to a target document which is a modification. Auto sourcing can be performed based on a contract number reference on the PR.

With respect to the allocation tracking feature, this feature provides the ability to determine where items originated and where items ended up. In addition to tracking all documents between the origination and the final document, allocation tracking also provides the capability of determining the allocation status of a particular item (e.g., whether it has been changed). In addition, allocation tracking provides the capability of determining the remaining quantity and remaining amounts on an ordering instrument line item. Allocation tracking also provides for the tracking of modifications so as to provide the ability to determine where a particular modified item originated. Finally, allocation tracking also provides the ability to determine the document level allocation status.

There are numerous manual allocation features provided by the present claimed invention including the ability to manually allocate a line item from a source document to a target document, the ability to manually match a source line item with an ordering instrument line item to create a target line item, the ability to manually modify a line item of an existing document such as a solicitation or award line item by allocating a change from a source line item. The manual allocation feature also provides the ability to add a new line item to a solicitation or award via modification, and to combine two source line items to create a single target line item. Manual allocation also provides the capability of combining a source line item with an existing target line item and to split by quantity or amount from a source line item. The manual allocation feature provides the capability of removing an allocated line item from an allocation summary and from a target document, as well as to allocate by quantity and amount. The manual allocation feature also provides the ability to view allocation summary details, ordering instrument details or solicitation/award details. The manual allocation feature also provides the ability to filter source line items based on filtering criteria established by line item.

The conflict detector feature of the present invention provides the ability to resolve line item data conflicts when combining line items and to resolve document level data conflicts when combining line items. For example, if a user attempts to provide a line item specifying blue pants with a line item specifying red pants, the conflict detector will note the inconsistency to the user by providing a warning screen, so that the conflict can be resolved.

There are also a variety of other allocation features which can be achieved with the present invention including the ability to allocate specific contract level data, attachments, clauses and all line item data, as well as to allocate and/or create a conformed copy of the target document.

The present invention has been described with respect to a specific implementation of a procurement system and with reference to various scenarios for the operations of the present invention. However, the features of the present invention may be applied to any procurement system and may be implemented to produce a variety of scenarios for handling line items as they are processed in the procurement system.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of managing a procurement process comprising manipulating at least one source document in order to transfer at least one line item from the at least one source document to at least one target document

2. The method as set forth in claim 1, wherein said manipulating comprises editing the at least one source document in order to allocate the at least one line item to the at least one target document

3. The method as set forth in claim 2, wherein said editing is performed automatically.

4. The method as set forth in claim 2, wherein said editing is performed based on user input.

5. The method as set forth in claim 1, wherein the at least one target document comprises first and second target documents and wherein said manipulating comprises splitting the at least one line item into first and second portions which are then transferred as line items on the first and second target documents, respectively.

6. The method as set forth in claim 1, wherein the at least one source document comprises first and second source documents, each having at least one line item, wherein said manipulating comprises combining the at least one line item from each of the first and second source documents into a single line item on the at least one target document.

7. The method as set forth in claim 1, wherein the at least one line item represents a quantity, a cost or a contract provision.

8. The method as set forth in claim 1, wherein the at least one line item on the at least one source document comprises first and second line items on a first source document which are transferred to a single line item on the at least one target document.

9. The method as set forth in claim 1, wherein the at least one line item on the at least one source document comprises a first line item on a first source document, and wherein said manipulating comprises splitting the first line item on the first source document into two line items which are transferred to the at least one target document.

10. A method for managing a procurement process comprising
editing at least one line item on at least one source document as the at least one line item is transferred to at least one target document; and
tracking said editing so as to retain a history of the editing of the at least one line item.

11. The method as set forth in claim 10, wherein said editing is performed automatically.

12. The method as set forth in claim 10, wherein said editing is based on user input.

13. The method as set forth in claim 10, wherein the at least one target document comprises first and second target documents, and wherein said editing comprises splitting the at least one line item into first and second portions which are then transferred to first and second line items on the first and second target documents, respectively.

14. The method as set forth in claim 10, wherein the at least on source document comprises first and second source documents, each having at least one line item, wherein said editing comprises combining the at least one line item from each of the first and second source documents into a single line item on the at least one target document.

15. The method as set forth in claim 10, wherein the at least one line item on the at least one source document comprises first and second line items on a first source document which are transferred to a single line item on the at least one target document.

16. The method as set forth in claim 10, wherein the at least one line item on the at least one source document comprises a first line item on a first source document, and wherein said editing comprises splitting the first line item on the first source document into two line items which are transferred to the at least one target document.

17. The method as set forth in claim 10, wherein the at least one target document is a delivery order, and wherein said editing comprises matching the at least one line item on the at least one source document to an ordering instrument, and transferring the at least one line item on the at least one source document to the delivery order.

18. A computer readable storage controlling a computer while editing at least one line item on at least one source document as the at least one item is transferred to at least one target document.

19. The computer readable storage as set forth in claim 18, wherein said editing is performed automatically.

20. The computer readable storage as set forth in claim 18, wherein said editing is performed based on user input.

21. The computer readable storage as set forth in claim 18, wherein the at least one target document comprises first and second target documents, and wherein said editing comprises splitting the at least one line item into first and second portions which are then transferred to first and second line items on the first and second target documents, respectively.

22. The computer readable storage as set forth in claim 18, wherein the at least one source document comprises first and second source documents, each having at least one line item, wherein said editing comprises combining the at least one line item from each of the first and second source documents into a single line item on the at least one target document.

23. The computer readable storage as set forth in claim 18, wherein the at least one line item on the at least one source document comprises first and second line items on a first source document which are transferred to a single line item on the at least one target document.

24. The computer readable storage as set forth in claim 18, wherein the at least one line item on the at least one source document comprises a first line item on a first source document, and wherein said editing comprises splitting the first line item on the first source document into two line items which are transferred to the at least one target document.

25. The computer readable storage as set forth in claim 18, wherein the at least one target document is a delivery order, and wherein said editing comprises matching the at least one line item on the at least one source document to an ordering instrument, and transferring the at least one line item on the at least one source document to the delivery order.

26. A procurement system comprising:
a procurement unit receiving information from a plurality of users and managing a procurement process involving source documents having line items and target documents having line items; and
an item allocator, coupled to said procurement unit, manipulating at least one line item on at least one of the source documents as the at least one line item is transferred to at least one of the target documents.

27. The procurement system as set forth in claim 26, wherein said item allocator manipulates the at least one line item on the at least one of the source documents by editing the at least one line item on the at least one of the source documents.

28. The procurement system as set forth in claim 27, wherein said editing is performed automatically by the said item allocator.

29. The procurement system as set forth in claim 27, wherein said item allocator receives user input and performs said editing based on the user input.

30. The procurement system as set forth in claim 26, wherein the at least one target document comprises first and second target documents and wherein the manipulation performed by said item allocator comprises splitting the at least one line item into first and second portions which are then transferred to first and second line items on the first and second target documents, respectively.

31. The procurement system as set forth in claim 26, wherein the at least one source document comprises first and second source documents each having at least one line item, and wherein said item allocator manipulates the at least one line item by combining the at least one line item from each of the first and second source documents into a single line item on the at least one target document.

32. The procurement system as set forth in claim 26, wherein the at least one line item on the at least one source document comprises first and second line items on a first source document which are transferred to a single line item on the at least one target document.

33. The procurement system as set forth in claim 26, wherein the at least one line item on the at least one source document comprises a first line item on a first source document, and wherein the manipulating performed by said item allocator comprises splitting the first line item on the first source document into first and second line items which are transferred to the at least one of the target documents.

34. The procurement system as set forth in claim 26, wherein said item allocator provides tracking of the manipulating so as to retain a history of the manipulation of the at least one line item.

35. The procurement system as set forth in claim 26, wherein the at least one of the target documents is a delivery order, and wherein said manipulating comprises matching the at least one line item on the at least one of the source documents to an ordering instrument, and transferring the at least one line item on the at least one of the source documents to the delivery order.

36. A procurement system comprising:
a procurement unit receiving information from a plurality of users and managing a procurement process involving source documents having line items and target documents having line items; and
means for manipulating at least one of the line items on at least one of the source documents as the at least one line item is transferred to one of the target documents.

37. A method of managing a procurement process, comprising:
providing a user with a display of a plurality of source documents for selection by the user, each of the source documents including at least one line item;
in response to the selection of at least one of the source documents by the user, manipulating the at least one line item on the selected source document and transferring the manipulated line item to at least one target document.

38. The method as set forth in claim 37, further comprising:
tracking said manipulating of the at least one line item so as to retain a history of the manipulation of the at least one line item.

39. The method as set forth in claim 37, wherein said manipulating comprises editing the at least one line item on the at least one source document by combining or splitting the at least one line tem.

40. The method as set forth in claim 37, wherein said manipulating comprises matching the at least one line item to a line item on a reference document, and transferring the matched line item to the at least one target document.

41. The method as set forth in claim 40, wherein the reference document is an ordering instrument and the at least one target document is a delivery order.

42. The method as set forth in claim 40, wherein the reference document is a procurement document and the at least one target document is a modification to an existing contract.

43. A method of managing a procurement process comprising editing at least one source document in order to transfer at least one item from the at least one source document to at least one target document.

44. A procurement system comprising:
a procurement unit receiving information from a plurality of users and managing a procurement process involving source documents having items and target documents having items; and
an item allocator, coupled to said procurement unit, editing at least one item on at least one source document as the at least one item is transferred to at least one of the target documents.
